(19) United States
(12) Patent Application Publication
(10) Pub. No.: US 2022/0225700 A1
(43) Pub. Date: Jul. 21, 2022

(54) FACE MASK WITH RESEALABLE OPENING

(71) Applicant: Cathy Samuel, Tuscaloosa, AL (US)

(72) Inventor: Cathy Samuel, Tuscaloosa, AL (US)

(21) Appl. No.: 17/149,720

(22) Filed: Jan. 15, 2021

(51) Int. Cl. A41D 13/11; A62B 18/08

(52) U.S. Cl. CPC A41D 13/1115; A62B 18/086; A41D 13/1161

(57) ABSTRACT

Illustrated views of an exemplary face mask for protecting people from spreading infectious diseases and to allow an opening to speak, eat, talk, etc. is presented. The face mask is useful for allowing a mouth and a nose of a person to be exposed or covered without removing the face mask. The opening of the face mask is useful for the person to eat, drink, talk on the phone, to talk in conversation when socially distant, etc.

### FIELD OF THE INVENTION

This invention relates to face masks. More particularly, it relates to a removable opening of the face mask.

### BACKGROUND

The ongoing COVID-19 pandemic was confirmed to have reached the United States in January 2020. The first confirmed case of local transmission was recorded in January, while the first known deaths happened in February. By the end of March, cases had occurred in all 50 U.S. states, the District of Columbia, and all inhabited U.S. territories except American Samoa. As of Jun. 24, 2020, the U.S. had the most confirmed active cases and deaths in the world. As of Jul. 16, 2020, its death rate was 419 per million people, the seventh-highest rate globally.

The Center for Disease Control (CDC) has issued a recommendation to the US population for prevention of contracting COVID 19 as well as other infectious diseases. Those recommendations are: 1) wash hands often; 2) Avoid close contact (social distancing); 3) cover mouth and nose with a cloth face cover when around others; 4) cover cough or sneezes; 5) clean and disinfect; and 6) monitor your health daily.

Recent events in our history remind us how susceptible humans are to contaminants in the air we breathe. Whether such contaminants are incidental such as dust, dirt, allergens or the like, or something more dangerous such as bacteria and viruses, many people turn to the use of scarves, masks or respirators for protection. While each of these offer varying levels of protection, face masks are often cumbersome to remove and put back on, while also causing some people to breathe their own carbon monoxide back in. This forces the user to make the decision to proceed without the mask with associated health risks, or have trouble breathing. When no one is within the recommended distance, the user may prefer to open or remove the face mask for ease of breathing.

Accordingly, and in light of the foregoing, there exists a need for a means by which an opening over a mouth of a user can be displaced or removed from a face mask such that the face mask can always be readily available for personal respiratory protection. The development of the face mask with a removable opening fulfills this need.

### BRIEF DESCRIPTION OF THE DRAWINGS

FIG. 1A is an illustrated view of an exemplary face mask.

FIG. 1B is a first illustrated view of the with a removable cover displaced from the exemplary face mask shown in FIG. 1A.

FIG. 1C is a second illustrated view of the with a removable cover displaced from the exemplary face mask shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

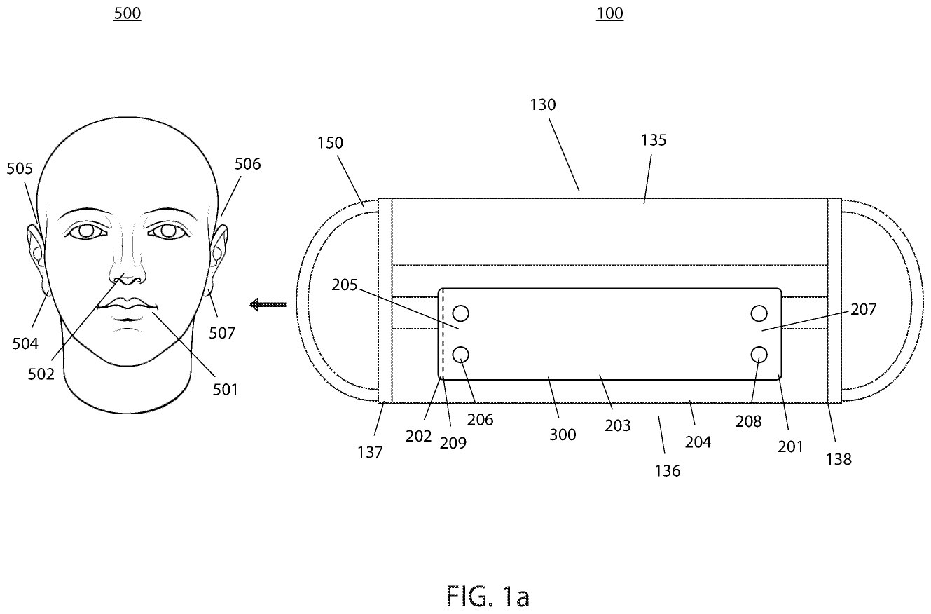

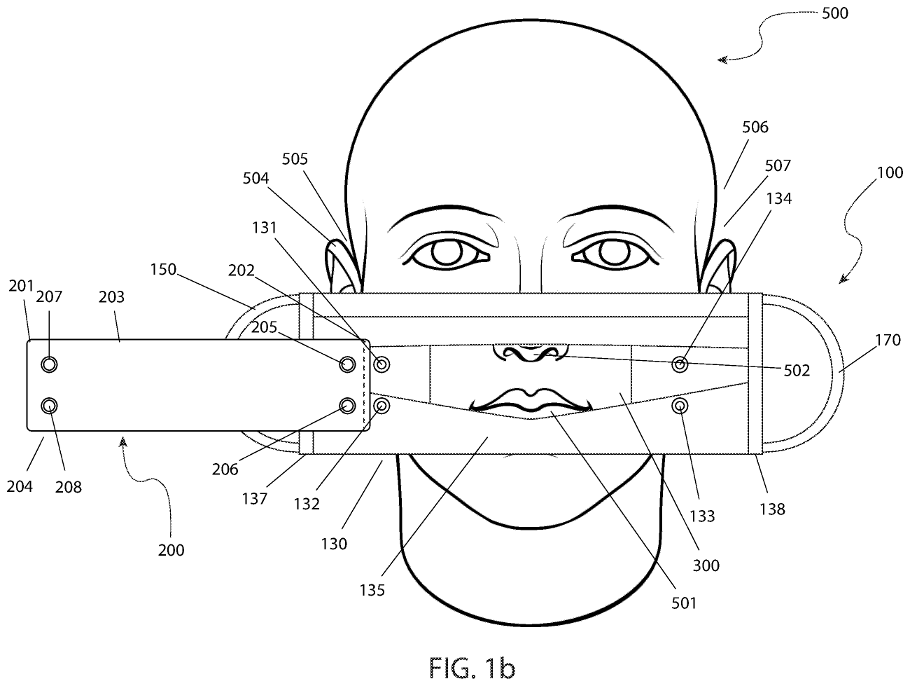

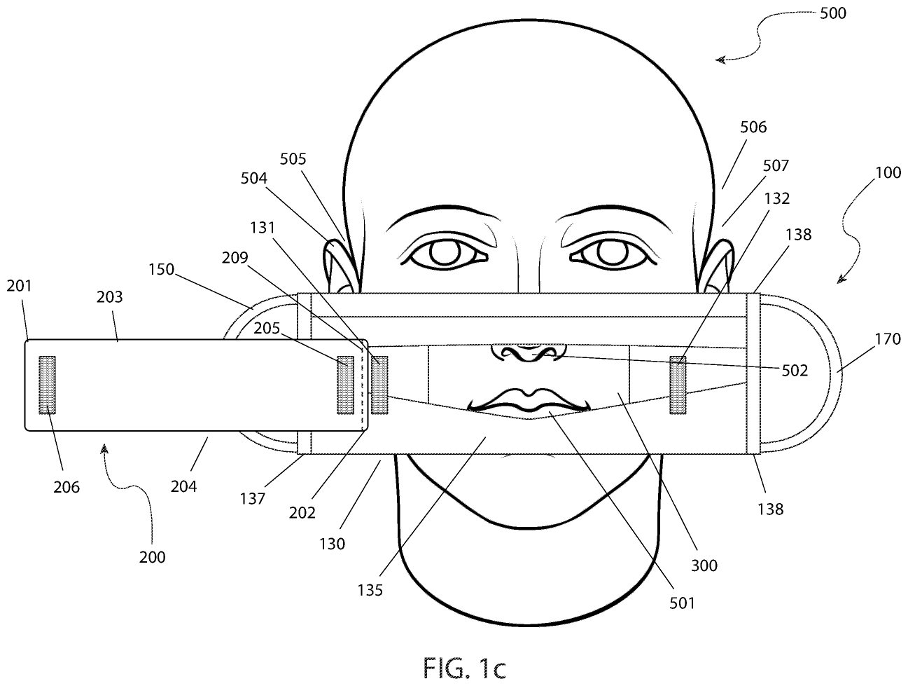

Referring to FIG. 1A, FIG. 1B and FIG. 1C are illustrated views of an exemplary face mask 100 for protecting people from spreading infectious diseases and to allow an opening 200 to speak, eat, talk, etc. is presented. The face mask 100 is useful for allowing a mouth 501 and a nose 502 of a person 500 to be exposed or covered without removing the face mask 100. The opening 200 of the face mask 100 is useful for the person 500 to eat, drink, talk on the phone, to talk in conversation when socially distant, etc.

The face mask 100 has a panel 130, one or more ear connectors 150, 170, the opening 200 and a cover 300. The face mask 100 is preferably made of a cloth material, however other materials are hereby contemplated, including, but not limited to, paper, polypropylene, etc. The panel 130 of the face mask 100 is preferably ten (10) inches in width, however other widths are hereby contemplated, including, but not limited to, seven inches (7″), eleven inches (11″), etc. The one or more ear connectors 150, 170 are preferably made of an elastic material, such as rubber bands, etc., however other types of materials are hereby contemplated, including, but not limited to, string, rope, etc.

The panel 130 has a first side 135, a second side 136, a first end 137 and a second end 138. The first of the ear connectors 150 is coupled to the first end 137 of the panel 130. The second of the ear connectors 170 is coupled to the second end 138 of the panel 130.

The panel 130 is preferably intended to cover a nose 502 and mouth 501 of a person 500. The first of the ear connectors 150 is moved over and then coupled to a back 505 of a right ear 504 of the person 500. The second of the ear connectors 170 is coupled moved over and then coupled to a back 506 of a left ear 507 of the person. The panel 130 is configured to cover the mouth 501 and nose 502 of the person 500.

The panel 130 further has one or more female ended cover connectors 131, 132, 133, 134 shown in FIG. 1B and FIG. 1C. The cover connectors 131, 132, 133, 134 are preferably snap connectors, as shown in FIG. 1A and FIG. 1B, however other types of connectors are hereby contemplated, including, but not limited to, hook and loop fastener, such as a Velcro® fastener, as shown in FIG. 1C, a button, a clip, etc. Each of the cover connectors 131, 132, 133, 134 may be one or more of the different types of connectors such that for example, cover connectors 131, 132 may be snap connectors while the cover connector 135 and/or 136, shown in FIG. 1C, may be a hook and loop fastener connector. Therefore, it has been contemplated that the connectors are a mix and match condition for determining what works best for a given instance based on cost of goods, consumer desire, etc.

The cover 200 has a first side 201, a second side 202, a first end 203 and a second end 204. The first end 203, optionally and or additionally, has one or more male ended cover connectors 205, 206. Optionally and or additionally, the second end 204 of the cover 200 may have the one or more male ended cover connectors 207, 208. Further, the first end 203 of the cover 200 may optionally, and or additionally, has a seam 209, where the seam 209 is used for coupling the first end 203 of the cover 200 to the panel 130.

The female ended cover connectors 131, 132, 133, 134 and the male ended cover connectors 205, 206, 207, 208 are configured to be coupled and decoupled to allow the cover 200 to be opened or closed from the second end 138 of the panel 130 or to be removable and attachable to the panel 130 of the face mask 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claim is:

1. A face mask for protecting a person from spreading infectious diseases and to allow the person to speak, eat, talk, etc., the face mask comprising:
a panel, the panel having a first side, a second side, a first end and a second end;
one or more female ended connectors;
one or more ear connectors, the first of the one or more ear connectors being coupled to a back of a right ear of the person, the second of the one or more ear connectors being coupled to a back of a left ear of the person, wherein the ear connectors being for securing the face mask to the person;
an opening, the opening being configured to extend over a nose and mouth of the person; and
a cover, the cover having one or more male ended connectors, the male ended connectors being for configured to couple the cover to the female ended connectors of the panel of the face mask.

2. The face mask of claim 1, wherein the male ended connectors being snap connector.

3. The face mask of claim 1, wherein the male ended connectors being a hook and loop fastener.

4. The face mask of claim 1, wherein the female ended connectors being snap connector.

5. The face mask of claim 1, wherein the female ended connectors being a hook and loop fastener.

6. The face mask of claim 1, wherein the cover being removable.

7. The face mask of claim 1, wherein the cover being detached from the second end of the panel.

8. The face mask of claim 1, wherein the panel being a width of ten inches (10″).

9. The face mask of claim 1, wherein the ear connectors being made of an elastic material.

10. The face mask of claim 10, wherein the elastic material being rubber bands.

11. The face mask of claim 1, wherein the face mask being made of a cloth material.
